(19) United States
(12) Patent Application Publication
(10) Pub. No.: US 2013/0024286 A1
(43) Pub. Date: Jan. 24, 2013

(54) MULTIPLE SLACK VARIABLES FOR BALANCING AD CAMPAIGN RISKS

(71) Applicants: IZZET CAN ENVARLI, Kirkland, WA (US); ROHAN BHATTACHARJEE, Redmond, WA (US); ROBERT PAUL GORMAN, Woodinville, WA (US); ERWIN KALVELAGEN, Washington, DC (US)

(72) Inventors: IZZET CAN ENVARLI, Kirkland, WA (US); ROHAN BHATTACHARJEE, Redmond, WA (US); ROBERT PAUL GORMAN, Woodinville, WA (US); ERWIN KALVELAGEN, Washington, DC (US)

(73) Assignee: MICROSOFT CORPORATION, Redmond, WA (US)

(21) Appl. No.: 13/188,272

(22) Filed: Jul. 21, 2011

(51) Int. Cl. G06Q 30/00

(52) U.S. Cl. 705/14.61

(57) ABSTRACT

Systems and methods are provided for evaluating candidate orders relative to available inventory, such as evaluating candidate orders of advertising impressions relative to an estimated available inventor of advertising impressions. The evaluation can include matching orders with available inventors based on linear programs that include objective functions and constraints. At least one objective function can include multiple slack variables.

### BACKGROUND

Online advertising can be an important piece of the marketing campaigns and sales strategies of many client businesses, advertisers, or content providers. In order to accommodate advertisers wishing to post online advertisements, web pages are often designed to offer content regions therein for sale. These content regions can be configured to present advertisements to the end user upon navigating to the web pages. However, these advertisements may be presented only if the advertisers place orders to purchase a particular number of display instances, or impressions. A delivery engine can be responsible for accepting the orders and distributing the advertisements for presentation at the content regions of selected web pages.

Typically, when an order is placed to a delivery engine, the order can be guaranteed upon acceptance of the order. That is, the delivery engine can make a commitment to show the number of impressions as instructed in the order. For instance, if an advertiser places an order for one million impressions of a particular advisement, acceptance of the order by a delivery engine corresponds to an agreement that the delivery engine will cause each of the one million impressions to occur. If the delivery engine does not meet its obligation to present each of the one million impressions of the advertisement, or underdelivers, the advertisers may experience customer dissatisfaction which may result in the delivery engine losing business or being forced to offer rebates to retain their current business. This problem of fulfilling the orders accepted by the delivery engine can be exaggerated in the situation where the delivery engine is servicing multitudes of advertisers that each place various orders with different time frames for presenting impressions of the advertisements being ordered.

Conventional mechanisms for ascertaining how to deliver ordered impressions of advertisements and for determining whether inventory is available for accepting new orders can be labor-intensive (e.g., requiring a considerable amount of user-initiated tracking and calculations) and are not fluid, flexible, or efficient. Further, these conventional mechanisms are ad-hoc solutions that cannot dynamically react to a change in orders or inventory. As such, employing a sequence of linear programs that dynamically identify optimal allocations of the available inventory, and that facilitate deciding whether to accept a new order by evaluating currently accepted orders along with the new order against available inventory, would enhance the advertiser's experience when conducting a marketing campaign via the delivery engine

### SUMMARY

In various embodiments, systems and methods are provided for evaluating candidate orders relative to available inventory, such as evaluating candidate orders of advertising impressions relative to an estimated available inventor of advertising impressions. The evaluation can include matching orders with available inventors based on linear programs that include objective functions and constraints. At least one objective function can include multiple slack variables.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 is a block diagram of an exemplary computing environment suitable for use in implementing embodiments of the present invention.

FIG. 2 schematically shows a network environment suitable for performing embodiments of the invention.

FIG. 3 schematically shows an example of a content node diagram.

FIG. 4-6 show examples of methods according to various embodiments of the invention.

### DETAILED DESCRIPTION

### Overview

In various embodiments, systems and methods are provided for evaluating whether to accept new advertising orders based on existing orders and the predicted available inventory. The evaluation can be performed in part by using linear programs to balance various constraints of the evaluation, such as increasing revenue from advertising, reducing the number of undelivered advertisements, and providing relatively even distribution of advertisements over the course of a time period associated with an order. At least one of the linear programs can include multiple slack variables that are related to a goal of the evaluation. The multiple slack variables can allow the goal to be expressed in a tiered manner. Additionally or alternately, the multiple slack variables can allow a linear program to model a non-linear function. For example, with regard to a goal of reducing or minimizing underdelivery of advertisements, a plurality of constraint variables can be used. This can allow a small amount of underdelivery to have a low cost in the evaluation, while any underdelivery beyond a threshold value can have a substantially higher cost.

In some embodiments, the invention can relate to computer-readable media and a delivery engine for employing one or more linear programs to determine whether to accept a candidate order, submitted by an advertiser, by taking into account booked orders competing for inventory. Generally, the booked orders can be orders offered by customers of the delivery engine and previously accepted by the delivery engine. The delivery engine can include a processing unit coupled to a computer storage medium that stores a plurality of computer software components executable by the processing unit. Incident to execution, the computer software components can perform various operations that may include one or more of the following processes: receiving the candidate order with associated placement criteria or display specification; and estimating an inventory of impressions that are available for accommodating the candidate order and meeting the placement criteria or display specification. By way of example, the display specification for an order may identify a quantity of impressions of advertisement(s) to place, a time segment over which the quantity of impressions are anticipated to be placed, and at which node in a topic graph the impressions are expected to be rendered.

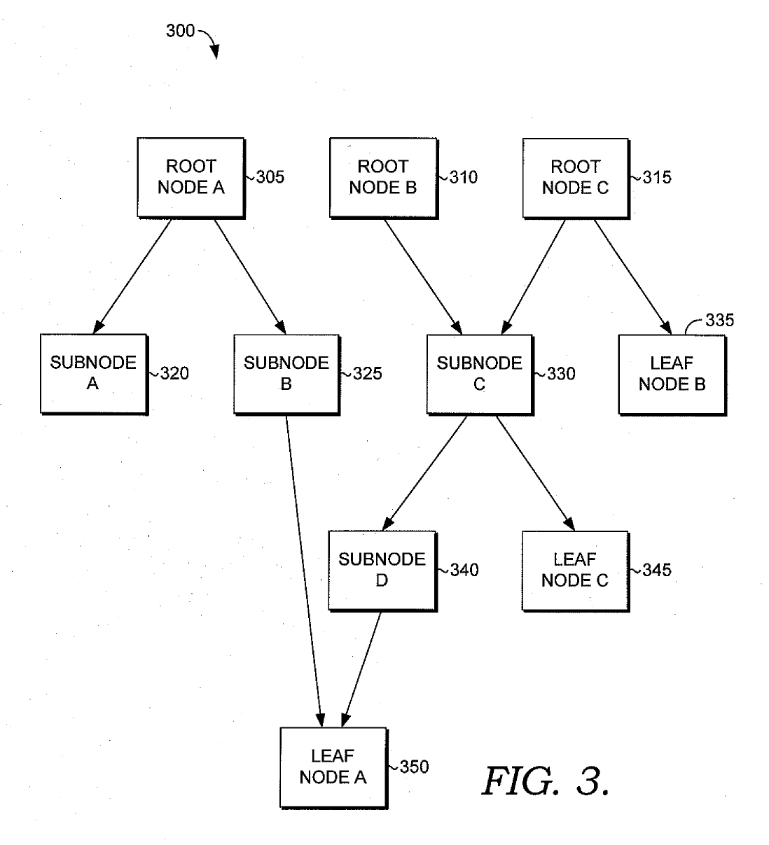

As described herein, and as more fully discussed with reference to FIG. 3, a node represents predefined subject matter that a content provider may specify when selecting criteria for placing their advertisements online. That is, as used herein, the term “node” relates to a location within a topic graph, where the location of the node represents a specific description of the inventory that is permissible to allocate for satisfying the candidate order. By way of example, the description of the article of inventory includes properties that expose a context of a web page, while the inventory includes one or more content regions within the web page that are reserved for presenting impressions as instructed by the delivery engine. By way of example, a node may be associated with “sports.” Accordingly, the candidate order can be filled by placing impressions in content regions of web pages that are in the “sports” area of some web site, or on a web page that has been identified as being sports-related. The web page and/or content region of the web page can alternatively be associated with a sub-node or child node of “sports”, such as being in the “baseball” area of a web site or on a web page that is identified as being related to golf.

The computer software components may be configured to perform additional operations such as identifying a log of one or more booked orders scheduled to be placed within the time segment. Typically, the identified booked orders can compete with the candidate order to be placed at each candidate node. In embodiments, a first linear program may be utilized to calculate a number of impressions of the candidate order and/or the competing booked orders that may be undelivered if a candidate order is accepted. In one instance, calculating the number of orders that include undelivered impressions may be accomplished by comparing the estimated inventory against the requested impressions in the joined orders. A second linear program may be utilized to calculate a portion of the impressions that are substantially nonuniformly delivered and a financial value of the estimated inventory allocated to the candidate order. These linear programs can be evaluated simultaneously or sequentially. Upon evaluating the outputs calculated by the first and second linear programs, a decision to accept a candidate order can be made. In an exemplary embodiment, when the number of undeliverable impressions from orders is low or zero and when a small portion of the impressions are substantially nonuniformly delivered, the candidate order can be accepted.

Embodiments of the present invention can relate to determining whether to accept a candidate order from a content provider or advertiser. The candidate order can correspond to a number of impressions, such as advertisements, to be displayed within a specified time segment. Initially, the content provider may include placement or display criteria that, for example, identify a node at which impressions of the advertisement are expected to be rendered. Generally, an identification of a node as part of placement criteria or a display specification can describe inventory that is permissible to allocate to satisfy the candidate order. The described inventory can be referenced, for example, as inventory associated with the identified node and any child nodes of the identified node. The placement criteria can further specify a time period for display of the impressions.

To perform a determination of whether a candidate order can be accepted, the inventory of impressions available for accommodating the candidate order and a log of booked orders scheduled to be placed within a time segment for the candidate order may be estimated and/or identified. Linear programs can then be utilized to determine whether sufficient estimated inventory that satisfies the placement criteria is available by predictively placing the booked orders within the estimated inventory. The estimated inventory can be determined as available if the benefit of accepting the candidate order (such as additional revenue generated) has a greater weight than a cost of accepting the candidate order, such as costs due to underdelivery or delivery in a non-uniform manner relative to the display specification for an advertisement order. Alternatively, the costs associated with accepting the order can be evaluated against a separate standard that is unrelated to the revenue from accepting the order. If the evaluation determines that sufficient inventory is available, the candidate order can be accepted.

As utilized herein, the term “inventory” is meant to be limiting, but may encompass any online space that is for sale. In one embodiment, inventory relates to one or more impressions being sold to an advertiser from a delivery engine. Impressions can be revealed or displayed when a user navigates to web page that publishes advertisements and that matches the display specification for an order. The impression may be published at any content regions (e.g., banner, side rails, footer of the web page, and the like), or locations, on the web page that can accommodate an advertisement. Accordingly, a daily inventory may be calculated based on the expected number of impressions published by each web page, the number of web pages that are accessible to the delivery engine, and the expected number of times each of the web pages are launched by end users within a day. As more fully discussed below, the ads that are selected by the delivery engine for placement within a web page can be selected based on the context of the web page, the known attributes of the user visiting the web page, and/or other factors that cause the impressions for a web page to match a display specification for an advertising order.

In another embodiment, the inventory may be any type of commerce-related product or service placement in which a collection of items is to be managed. In the case of targeted advertising applications, the inventory to be managed can be ad impressions. In other inventory management applications, the inventory to be managed can be, for example, products that need to be sold. For example, there may be a limited number of a certain kind of product to be sold, such that the use of an embodiment of the invention describes the best way in which to advertise the selling of the products.

Thus, embodiments of the present invention can pertain to allocating an inventory of impressions to fulfill orders, such that a given ad can be selected and displayed as an impression. In other instances, the invention can pertain to allocation of any item, such as physical advertising space, such that a given item can be selected and effected, where in the case of ads, effected means displayed. Besides ads, items can include products, services, etc. Furthermore, the effecting of an item can mean other things besides the displaying of an ad, such as the displaying of a button on a web site for immediate purchase of an item.

Accordingly, embodiments of the present invention can relate to a way to book orders (i.e., requests for a certain amount of inventory (impressions) over a time period), and to distribute the booked orders to appropriate web pages. As more fully discussed below, the appropriate web pages, or placement of the impressions, are governed by which node is targeted by a content provider. Generally content providers can employ targeting to focus on a node and/or other indicia of a web page context. Further, the content providers may employ targeting to limit the placements of an advertisement based on user-demographics (e.g., gender, age, and the like), user behaviors, and other criteria that the delivery engine can access and use to filter the impressions.

Generally, a delivery engine can accept or reject orders for delivering advertisements. One method for accepting an order can be based on a content provider paying a premium for a number of impressions. Additionally or alternately, an advertising auction can be conducted that includes receiving bids submitted by the content provider and/or competing customers. Bids of competing customers are not generally considered in a direct manner in the model discussed below because once an order is listed as booked, the monetary transaction has transpired. However, the bids can be indirectly incorporated into the first objective function as a weighting factor, such as a weighting factor to define advertiser-specific constants that represent the relative importance of each advertiser to the content provider. The advertiser-specific constants can be represented by a weighting factor or constant AV (advertiser value) in the linear programs. Accordingly, if the delivery engine is faced with the need to underdeliver ads of accepted orders, the AV weighting factor can be used to determine which ads not to place. In one embodiment, the AV weighting factor can help demonstrate the underdelivery cost, where the underdelivery cost is typically higher for the higher-paying advertisers. Other inputs that can be used to determine an AV constant or weighting factor can be the length of time that the owner of the delivery engine has worked with the advertiser, an overall value of an advertiser across multiple orders, or other factors specific to an advertiser. For example, if a high-paying advertiser has a low level of concern regarding impressions are underdelivered, but a medium-paying advertiser is threatening to cancel all future deals upon seeing an underdelivered order, then corresponding AV constants can take into account this characteristic, resulting in a higher AV constant for a lower paying advertiser.

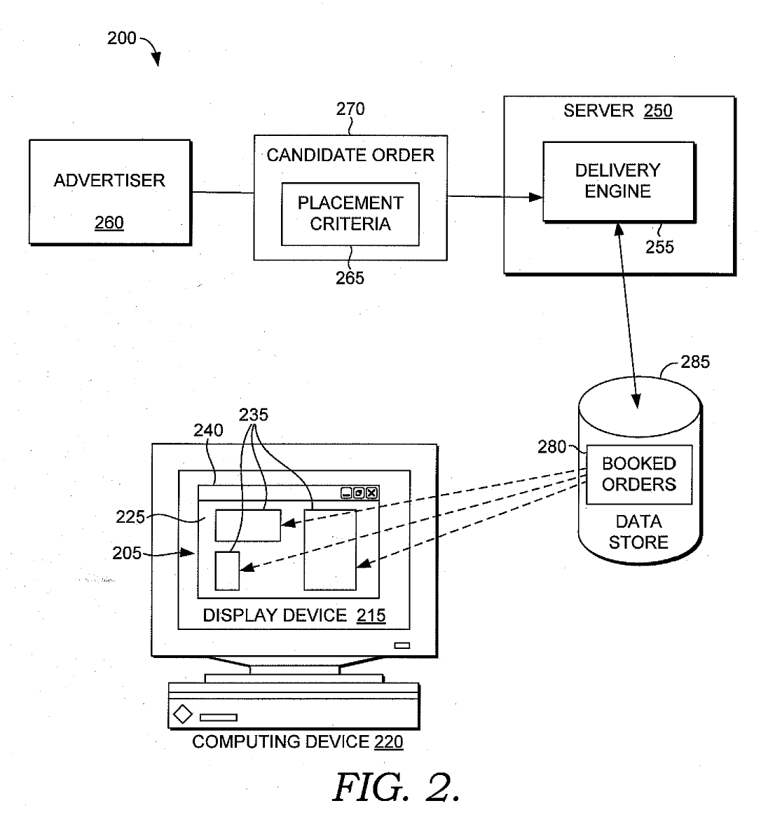

As used herein, the phrase “delivery engine” is not meant to be limiting but may encompass any entity or software that manages filling orders and/or conducts transactions that facilitate surfacing ad impressions. The delivery engine is discussed more fully below with reference to FIG. 2.

The decision of whether to accept a new order will now be discussed with reference to potential impressions organized as “nodes.” In various embodiments, other choices for organizing potential advertising impressions can also be selected. Nodes can be used to organize potential advertising impressions based on the web display page that contains the impression. The nodes can be organized in any convenient manner, such as by organizing the nodes in a hierarchy of subject matter. For example, one high level node description can be “news”. Nodes one level below the news node can be “sports news”, “weather news”, and “political news”. Nodes one level below sports news can be “baseball news” and “basketball news”. Note that the path to a node does not need to be unique, so “sports news” can potentially be a node below both a “news” category and a “sports” category.

One example of a node hierarchy can be a topic graph (see reference numeral 300 of FIG. 3). Generally, a topic graph can be composed of a plurality of nodes that are interconnected by way of a parent-child relationship, where each of the plurality of nodes represents a description of an article of the inventory (e.g., content region on a web page) being used to fulfill the booked orders. Accordingly, nodes may be arranged in a hierarchy with various parent nodes (general descriptions of articles) connected to various child nodes (narrow descriptions of articles). A child node that is a particular description of an article, or a bottom node of the hierarchy constructed by the topic graph, is referred to herein as a “leaf node.” In an exemplary embodiment, a leaf node can be the most specific content description that is defined by the delivery engine.

In operation, a content provider can target a leaf node or any other nodes that are non-leaves when specifying criteria for placement. In some embodiments, if the content provider targets a node that is a parent of leaf nodes, the delivery engine can assume that the content provider does not have a preference as to which leaf node the ordered advertisements are assigned. By way of example, when a content provider orders one million impressions of an advertisement at a parent node, the order can be satisfied if a million impressions are shown with the advertisement at any child node and/or leaf node that is a descendant of the parent node. The process of assigning can be accomplished by solving the linear programs discussed below and typically involves making predictions about available volume, etc, with respect to the nodes that match the display specification in the order from the content provider. Alternatively, if the content provider targets a leaf node, then the delivery engine can be restricted to assigning the ordered advertisements to just that leaf node (e.g., placing impressions for pages that belong to that only that leaf). Accordingly, from the point of view of the delivery engine, parent nodes represent disjunctions of leaf nodes.

In various embodiments, a delivery engine can be responsible for determining whether to accept a new order, or “candidate order,” from an advertiser. This determination may be facilitated by executing one or more linear programs. Linear programs are employed to solve linear objective functions with variables that an operator can control and with constraints that are linear. Accordingly, linear functions can express optimization problems as a linear object function, thus, computing tools can easily solve for the optimal setting of the variables efficiently.

Those of ordinary skill in the art will recognize that this linear program may be solved by any of a variety of methods within the prior art. In one embodiment, for example, the Simplex Algorithm, developed in the 1940s and known within the art is used. The Simplex Algorithm is an iterative procedure for solving linear programming problems, which include finding the optimum of a linear function subject to a number of linear constraints. The Simplex Algorithm is thus a computational tool for solving linear programming problems and is able to provide fast solutions to large-scale applications. Solving the linear program presented above and below thus yields the allocation of ads within the inventory, such that the placement criteria is met.

In some embodiments, a plurality of linear programs can be solved simultaneously. In this discussion, simultaneous solution of linear programs refers to solving linear programs that share one or more common variables. Rather than solving for a first linear program and fixing one or more values based on the first solution, the linear programs can be solved simultaneously so that variables of interest do not become fixed until a solution is arrived at for all of the variables that are part of the simultaneous solution.

Simultaneous solution of a plurality of linear programs can allow for optimization of assignment of impressions based on multiple constraints. For example, if constraints are solved sequentially, impressions can be assigned based first on satisfaction of an underdelivery constraint. After assigning the amount of underdelivery for each order, sequential solution can allow for solution of the constraint related to the smoothness of delivery of the advertisements over time. The constraint can be designed to deliver a smooth or more even distribution of impressions over time. However, when sequential solution is used, the amount of underdelivery for each order cannot be modified in order to improve the smoothness of delivery.

In various embodiments, at least one of the linear programs can include two or more constraint or slack variables that allow a non-linear behavior to be approximated by a linear program. For example, a first slack variable can be included in an object function related to underdelivery of impressions. The first slack variable can be limited to a small range of values, and the weight factor for the first slack variable can be relatively small. This can represent that a limited amount of underdelivery is acceptable to a client with a smaller penalty. A second slack variable can also be included in the object function that is not limited in range and that has a larger weight or penalty factor. The second slack variable can account for additional underdelivery of impressions for an order that is greater than a threshold. The amount of underdelivery larger than threshold amount represents a situation with a higher cost (such as a higher monetary or business relationship cost), and therefore has a larger associated weight or penalty factor. When a linear program including the underdelivery slack variables is minimized or otherwise solved, if only a small amount of underdelivery is present, the second slack variable can have a value of “zero”. This corresponds to a situation where the amount of underdelivery is less than the threshold amount, and therefore all of the underdelivery can be represented by the first slack variable. Multiple slack variables can similarly be used for other constraints, such as a constraint for smooth delivery of impressions over a time period associated with the display specification for an order. It is noted that this type of piece-wise linear approximation of a non-linear function is not suitable for use with a convex cost function. For example, piece-wise linear approximate can be used to approximate an exponential cost function, but not a logarithmic cost function.

A plurality of linear programs can be solved simultaenously to ascertain whether adding a candidate order will result in underdelivery of the currently booked orders and/or the new order. A first linear program can include a first objective function that attempts to minimize a risk of underdelivery when considering adding the candidate order. The first objective function can include one or more slack variables related to underdelivery. The first objective function can optionally be configured to always allocate impressions to orders that are booked in the system. If conditions arise (e.g., given a lowered capacity forecast) that prevent all orders from being delivered, the first objective function can prefer to underdeliver on low-valued order lines than on high-valued order lines. Accordingly, the first linear program can attempt to minimize the underdelivery cost. In some embodiments, this first objective function can include two or more slack variables, such as a plurality of slack variables related to underdelivery.

The following discussion provides an example of linear programs according to some embodiments of the invention. For ease of explanation, syntactic conventions for representing the linear programs will be used. Generally, variables are denoted with lower-case symbols (e.g., xijt, μj), and constants are denoted with upper-case symbols (e.g., Gj, D).

In an embodiment, the first linear program can identify an allocation x for the delivery engine, and calculate an underdelivery amount μⱼ for each candidate booked order. The first objective function of the first linear function may be expressed as

$${\sum }_{j} {AV}_{j} ( {u}_{j 1} + ZP * {u}_{j 2} )$$

which, when minimized, minimizes a risk of underdelivering the booked order over a time segment. As discussed above, uⱼ represents a number of impressions in booked orders (or booked orders plus the candidate order) that will be potentially undelivered upon accepting the candidate order. The factors uⱼ₁ and uⱼ₂ represent separate slack variables that can represent the underdelivered impressions. ZP represents a penalty weighting factor for underdelivered impressions that are represented by uⱼ₂. For example, ZP can have a value such as 10, 100, 500, 1000, or any other convenient value so long as ZP is greater than 1. Due to this additional penalty weight, underdelivered impressions are assigned first to uⱼ₁. Underdelivered impressions are only assigned to uⱼ₂ during optimization when uⱼ₁ has reached an upper limit. AVⱼ represents a weighting assigned to at least one customer that submitted the booked orders. The weighting may be assigned based on any number of characteristics of a customer, such as a bid (e.g., function of price per impression in a campaign), or the value attached to the particular advertiser. The value of AV may be low, for example, if the advertiser does not pay on time or may be high if the advertiser has a long-term contract and/or relationship with the delivery engine. Accordingly, AVⱼ (uⱼ₁+ZP*uⱼ₂) represents a cost to the delivery engine, adjusted per each customer, for underdelivering an order. That is, the delivery engine incurs a cost of at least AVⱼ for each non-delivered impression that occurs, and a cost of AVⱼZP for each non-delivered impression beyond a threshold value.

Within the first linear program, the objective function can be minimized while subject to constraints. Minimizing the object function of the first linear program subject to constraints may include minimizing the object function subject to first constraints such as

∀ⱼW_{c1}*Gⱼ≧uⱼ₁≧0

∀ⱼuⱼ₂≧0

of the first linear program. These first constraints can perform several functions. First, there is no benefit to overdelivery of impressions, as uⱼ₁ and uⱼ₂ must be greater than zero. It is noted that any penalty weighting factor ZP also has a value greater than one, in order to maintain the characteristic of having no benefit for overdelivery of impressions and to maintain a higher penalty value for underdelivery assigned to the unbounded slack variable uⱼ₂. Second, the first constraints limit the value of uⱼ₁ to a percentage of the value of G, where W_{c1} is the percentage (greater than zero) and where G represents the total impression goal for campaign j. The threshold for increased penalty due to underdelivery can be set at any convenient or desired level by selecting a corresponding value for W_{c1}. For example, can be constrained to be 5% of G (W_{c1}=0.05), or 10% of G (W_{c1}=0.1), or 25% of G (W_{c1}=0.25), or any other convenient percentage of G. Alternatively the upper limit for can be unrelated to G, and W_{c}G can be replaced by any other convenient term or value that provides an upper bound. Optionally, an upper limit for uⱼ₂ can also be provided. Such an upper limit would represent the fact that underdelivery beyond a second threshold does not incur an additional penalty or incurs a different penalty associated with still another slack variable. Still another option could be to include additional slack variables, such as a third slack variable uⱼ₃, to allow for a third (or more) additional region for accounting for underdelivered impressions. A separate penalty weighting factor can optionally be associated with each additional slack variable.

Further, minimizing the first object function of a first linear program subject to constraints may include minimizing the first objective function subject to a second constraint

$${∀}_{j} {\sum }_{i ∈ {L}_{j} , t ∈ {T}_{j}} {x}_{ijt} = {G}_{j} - ( {u}_{j 1} + {u}_{j 2} )$$

of the first linear program. In this constraint, Gⱼ represents the log of the booked orders scheduled to be placed at the leaf node within the time segment. In embodiments, Xᵢⱼₜ represents a solution vector (e.g., three-dimensional matrix, tensor, and the like) that specifies available allocations for the leaf node i during a time segment t. The variable j, as used herein, corresponds to the customer placing the order. Generally, solving the first object function in conjunction with the second constraint of the first linear program provides equivalence between the potential undelivered booked orders and the scheduled booked orders with consideration of periods of time Tⱼ within the time segment that the candidate order is active (e.g., only displaying ads on Mondays). The constant L represents the leaf node, or a set of leaves, that match the candidate order, or the leaf nodes that satisfy the target (e.g., path name) of the candidate order. Accordingly, the second constraint represents the delivery goals of the delivery engine and provides the equivalence between the uⱼₓ variables and the number of undelivered impressions.

In addition, minimizing a first object function of a first linear program subject to constraint(s) may include minimizing the first object function subject to a third constraint

$${∀}_{i , j , t} {x}_{ijt} \leq {C}_{it} {S}_{it} ( j ) p ( {U}_{j} ) - {\sum }_{k \neq js \cdot t \cdot {R}_{k} \geq {R}_{j}} {x}_{ikt} \frac{{S}_{it} ( j , k )}{{S}_{it} ( k )} p 〈 {U}_{j} \vert {U}_{k} 〉$$

of the first linear program. In operation, the third constraint ensures that the delivery engine cannot deliver, or allocate, more impressions than are estimated to be available at a leaf node per a time frame. In embodiments, the impressions that are estimated to be available can be based on a predicted number of user visits that correspond to a particular placement criteria or display specification. In addition to leaf nodes, the third constraint can consider customers that are specifying demographics and can be cognizant of the people's characteristics that are actually visiting a web page. For instance, the third constraints can look at 100 impressions available within the context or leaf node “football” and see that only 30 impressions are generated by female visitors.

Generally, the first term CᵢₜSᵢₜ(j)p(Uⱼ) represents the estimated inventory of impressions available that meet the placement criteria. That is, the first term represents a number of impressions available for order line j for leaf node i at time t, assuming no other orders are in the delivery engine. In particular, Cᵢₜ represents the total number of impressions that are expected to occur at a leaf node j within a segment of time t (e.g., 100 impressions per day at football web pages). Sᵢₜ represents the fraction of total impression volume at leaf node i that will arrive during time segment t in which order line j will be active. For example, if t is a one-day period covered by an order line j that specifies day-part targeting focusing on mornings, and if a third of the total daily hours at leaf node i on day t arrives during the morning, then Sᵢₜ=⅓. That is, Sᵢₜ represents a fraction of time available a customer that is interested in portioning the delivery over sections of a day (e.g., targeting hours within the day). pUj represents the probability that an impression at leaf node i will match the targets Uj. Accordingly, the first term finds the total number of impressions available during the time period t targeting the leaf node Cᵢₜ, of which only a fraction Sᵢⱼₜ will be available during the time that order j is active. Of these remaining impressions, a fraction p(Uⱼ) will actually match the targeting criteria of order j.

The second term

$${\sum }_{k \neq js \cdot t \cdot {R}_{k} \geq {R}_{j}} {x}_{ikt} \frac{{S}_{it} ( j , k )}{{S}_{it} ( k )} p 〈 {U}_{j} \vert {U}_{k} 〉$$

represents a portion of the estimated inventory of impressions that is ostensibly allocated to the booked orders submitted by customers that have a priority level which ranks higher or equal to a priority level assigned to an advertiser submitting the candidate order. In particular, the second term represents inventory that is subtracted away from the total available to order j due to the delivery engine serving impressions to orders of higher priority. In particular, for each competing order k with higher priority, the total number of impressions served to order k during the time segment t is xᵢₖₜ. Of these served impressions, a fraction are served during the time that both order j (candidate order) and order k (booked order) are active. Because, all of these impressions served to order k satisfy the targets Uk of the orders, the impressions that could have been delivered to order j and are not available due to order line k are represented by p(Uⱼ|Uₖ). The ratio represents an overlap in inventory volume that the customers and content provider compete for (e.g., percent of available volume per day is in competition with the candidate order). The variable p represents an overlap in targeted space. If disjoint (e.g., one customer targets male and a competitor targets female) then P=0.

Stated another way, the second term operates to subtract the impressions from candidate order that are directly competing against the advertiser submitting the candidate orders. However, only those impressions associated with competing customers of a higher priority are subtracted. For instance, priority is based on how an advertiser is targeting. By way of example, if customer 1 is targeting males, while customer 2 is targeting males over 18, customer 2 is granted higher priority because their placement criteria is more specific and the impressions within the inventory are more rare, thus, harder to find. However, in embodiments, customers that target gender will be given higher priority than content providers submitting orders that specify age. Because, these demographics do not directly overlap, the third constraint is conservative, so as not to over-allocate. Consequently, this conservative approach may prevent the engine from allocating inventory that it has available.

As such, minimizing the first object function subject to the third constraint of the first linear program comprises determining a number of impressions, which satisfy the placement criteria, within the estimated inventory that are available upon removing those impressions allocated to the high-priority-level customers. During this determination, the third constraint takes into account the active time periods and user-demographics designated by the booked orders. Typically, the placement criteria specifies the active time periods and the user-demographics associated with placing the candidate order.

Accordingly, upon solving the objective function using the three constraints above, the objective function will be zero if and only if there exists a capacity-conforming allocation that meets all of the delivery goals with no under delivery. If no such allocation exists, the first linear program will identify the allocation in which the underdelivery cost is minimized.

A second linear program can also be used. The second linear program can attempt to achieve two goals, minimizing both nonuniformity (i.e., maximizing smoothness of delivery) and minimizing the value of booked impressions. The first goal of maximizing smoothness can correspond to delivering impressions uniformly over time to a user, so that the advertisements from a given order are not bunched together. For instance, if a customer has an order to show one million ads, the first goal attempts to distribute the ads in a roughly even manner over the targeted time segment instead of showing all ads on the last day of the time segment. In other words, the first goal should manage the impressions in inventory to deliver the impressions to all advertisers across time in a roughly uniform manner. In an embodiment, the the cost assigned to deviating from this smoothness constraint can be increased as the value of an order increases.

The second goal of minimizing the value of booked impressions attempts to maximize the opportunity for allocating a leaf node, subnode, or root node in the topic graph to an order. If a node can be allocated easier because it corresponds with more orders, it may be more valuable. Or, if there is a large demand, and corresponding high payments, for a node, then there is a sense of how much it is worth and what the delivery engine can charge for impressions at that node. Accordingly, the second goal aspires to allocate the orders in such a way as to leave open the valuable inventory. In other words, the allocation should preserve valuable inventory for future sale. In particular, premium inventory should not be sold at a discount early in the sales cycle if the inventory would likely sell at a premium later.

In various embodiments, the goals of smooth delivery and preserving valuable inventory can be balanced against the goal of minimizing underdelivery. This balancing can be achieved in several ways. First, the linear programs above for minimizing underdelivery can be solved simultaneously with the linear programs below related to smooth delivery and preserving valuable inventory. This is in contrast to the scenario of first minimizing the underdelivery, and then using the underdelivery solution to provide fixed values in the linear programs for maximizing smooth delivery. Second, the relative value of each type of slack variable can be adjusted by using weighting factors.

As with the first linear program, the second linear program includes an objective function that is minimized subject to constraints. The second objective function

$$( \sum {AV}_{j} ( {δ}_{jt 1} + ZQ {δ}_{j t 2} ) ) + Γ ( {\sum }_{ijt} {X}_{ijt} {R}_{i} )$$

of a second linear program includes two terms. The first term (ΣAVⱼ(δⱼₜ₁+ZQδⱼₜ₂)) represents a uniformity at which the impressions are delivered throughout the time segment, thus, aligned with the first goal. In this first term, δᵢₜ₁ and δᵢₜ₂ represent the deviation that is beyond an allowed range of deviation. The greater the values of δᵢₜ₁ or δᵢₜ₂, the less uniform the distribution of the impressions. ZQ represents a weighting factor so that smoothness deviation beyond a threshold results in a greater penalty. The value of ZQ can be any convenient value greater than 1, such as 10, 100, 500, 1000, or another convenient value. The second term

$$Γ ( {\sum }_{ijt} {X}_{ijt} {R}_{i} )$$

of the two terms in the second linear function represents a value of the impressions that are allocated to the booked orders, thus, aligned with the second goal of maximizing the value of what is left, or minimizing the value of what is allocated for booked orders. In this second term, Γ represents a weighting factor that balances the importance of the two goals.

This second object function may be minimized using various constraints. In one instance, the various constraints may include a first pair of constraints

∀ⱼW_{c2}*DFⱼₜGⱼ≧δⱼₜ₁≧0

∀ⱼδⱼₜ₂≧0

of the second linear program. These first constraints of the second linear program can perform several functions. First, there is no benefit to excess smoothness in the delivery of impressions, as δⱼₜ₁ and δⱼₜ₂ must be greater than zero. Second, the constraints limit the value of δⱼₜ₁ to a percentage (based on W_{c2}) of the value of DFⱼₜGₜ, where DFG can represent a variation tolerance threshold. The threshold for increased penalty due to deviation from smooth delivery can be set at any convenient or desired level based on W_{c2}. For example, δⱼₜ₁ can be constrained to be 10% of DFG (W_{c2}=0.1), or 25% of DFG (W_{c2}=0.25), or 40% of DFG (W_{c2}=0.4), or another percentage of DFG, or alternatively the upper limit for δⱼₜ₁ can be unrelated to G if desired. Optionally, an upper limit for δⱼₜ₂ can also be provided. Such an upper limit would represent the fact that deviation from smooth delivery beyond a second threshold does not incur an additional penalty, or that a different penalty should apply for deviation beyond the second threshold. Still another option could be to include additional slack variables, such as a third slack variable δⱼₜ₃, to allow for a third (or more) additional region for accounting for deviation from smooth delivery of impressions. Optionally, separate penalty weights can be associated with each additional slack variable.

In another instance, the various constraints may include a second constraint

$${∀}_{j} {\sum }_{i ∈ {L}_{j} , t ∈ {T}_{j}} {x}_{ijt} = {G}_{j} - ( {u}_{j 1} + {u}_{j 2} )$$

of the second linear program. This second constraint is the same as the second constraint from the first object function. Optionally, the uⱼₓ values can be solved for in the first object function and then treated as a constant for the second linear program. Preferably, the first and second object functions are resolved simultaneously so that underdelivery can be balanced against smoothness of delivery and minimizing of booked value.

In embodiments, the object function of the second linear program may be minimized using a third constraint related to preventing overdelivery at a node, which is similar to the third constraint applied to the object function of the first linear program. Accordingly, the third constraint will not be discussed again.

In an exemplary embodiment, the second object function of the second linear program can be subject to a fourth constraint

$${∀}_{j , t} [ {\sum }_{i ∈ {L}_{j}} {x}_{ijt} - {F}_{jt} {G}_{j} ] \leq D {F}_{jt} {G}_{j} + ( {δ}_{j 1 t} + {δ}_{j 2 t} )$$

of the second linear program. The first term

$${∀}_{j , t} [ {\sum }_{i ∈ {L}_{j}} {x}_{ijt} - {F}_{jt} {G}_{j} ]$$

represents an accumulated difference between a uniform distribution and a scheduled allocation of the impressions over the time segment t. In particular, Fⱼₜ represents the fraction of a total advertising campaign time that order j will be active during time segment t. For example, if t is a one-day period covered by the order j that is running for seven days, Fjt= 1/7.

Generally, the second term DFⱼₖGⱼ represents a variation-tolerance threshold, while δⱼₜ₁ and δⱼₜ₂ represent a distance of deviation from a prescribed range of uniformity. The sum of these elements represents the total number of impressions delivered to order j in time segment t. If the allocation were perfectly uniform across time, then the fraction of the delivery goal Gⱼ that would be delivered in this time segment would be Fⱼₜ (i.e., the fraction of total campaign time spent in segment t). Fixed constant D is the range (e.g., number of impressions) that the delivery engine allows the allocation to deviate from a perfect uniformity. If any allocation is not within this fixed constant, a positive value of δⱼ₁ₜ or δⱼ₂ₜ is generated in order to not violate the third constraint. A higher value of δⱼ₁ₜ will incur a somewhat higher cost in the second objective function, while a higher value of δⱼ₁ₜ will incur a still greater cost, depending on the value of ZQ.

Upon solving the first and second linear programs, either simultaneously or in sequence, the delivery engine can determine whether to accept the candidate order. For example, the first object function of the first linear program corresponds to a sum. The second object function can be used to produce a similar value. These values can be used alone, in combination, and/or in combination with other factors to generate a score. For example, if the score is below a threshold value, the candidate order can be accepted, while a score above the threshold can result in rejection of the candidate order. In addition, the delivery engine can use the results of the linear programs to determine if the constraints are still accurate. For instance, the delivery engine may determine that the estimate of inventory is not appropriate based on the results of solving the linear programs and issue an updated inventory estimate.

Another variation on the above can be to add relative importance weighting factors for each of the slack variables. The relative importance weighting factors for the slack variables can allow for control of the relative importance of the constraints. For example, if the value of underdelivery is considered to be 100 times the value of deviation from smooth delivery, a corresponding weighting factor can be added to the above equations to reflect this relative importance. This can reflect a situation where avoiding underdelivery of impressions has a greater importance than smooth delivery of the impressions that are delivered.

Having briefly described an overview of embodiments of the present invention and some of the features therein, an exemplary operating environment suitable for implementing the present invention is described below.

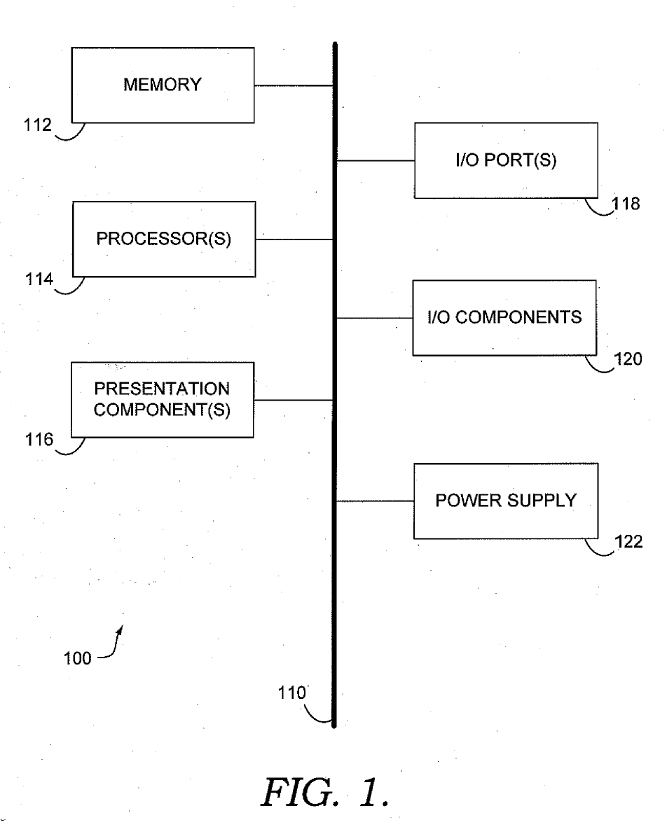

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

The computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

Turning now to FIG. 2, a schematic diagram of an exemplary system architecture 200 suitable for use in implementing embodiments of the present invention is shown, in accordance with an embodiment of the present invention. It will be understood and appreciated by those of ordinary skill in the art that the exemplary system architecture 200 shown in FIG. 2 is merely an example of one suitable computing environment and is not intended to suggest any limitation as to the scope of use or functionality of the present invention. Neither should the exemplary system architecture 200 be interpreted as having any dependency or requirement related to any single component or combination of components illustrated therein.

As illustrated, the system architecture 200 may include a distributed computing environment, where a computing device 220 is operably coupled to a server 250. In embodiments of the present invention that are practiced in the distributed computing environments, the operable coupling refers to linking the computing device 220 to the server 250, and other online components (e.g., booked orders 280 within the data store 285) through appropriate connections. These connections may be wired or wireless. Examples of particular wired embodiments, within the scope of the present invention, include USB connections and cable connections over a network 201. Examples of particular wireless embodiments, within the scope of the present invention, include a near-range wireless network and radio-frequency technology. It should be understood and appreciated that the designation of “near-range wireless network” is not meant to be limiting, and should be interpreted broadly to include at least the following technologies: negotiated wireless peripheral (NWP) devices; short-range wireless air interference networks (e.g., wireless personal area network (wPAN), wireless local area network (wLAN), wireless wide area network (wWAN), BluetoothTM, and the like); wireless peer-to-peer communication (e.g., Ultra Wideband); and any protocol that supports wireless communication of data between devices. Additionally, persons familiar with the field of the invention will realize that a near-range wireless network may be practiced by various data-transfer methods (e.g., satellite transmission, telecommunications network, etc.). Therefore it is emphasized that embodiments of the connections between the computing device 220 and the remote server 250, for instance, are not limited by the examples described, but embrace a wide variety of methods of communications. In another embodiment, the computing device may internally accommodate the functionality of the server 250, thereby alleviating dependence on wireless or wired connections.

Exemplary system architecture 200 includes the computing device 220 for, in part, supporting operation of the display device 215. The computing device 220 is configured to present a graphical user interface (GUI) workspace 205 (e.g., UI display) on the display device 215. In one instance, the GUI workspace can present a display area 230 that contains a web page 225. The web page 225 may include one or more content regions 235 that present one or more impressions of ads to an end user that has navigated to the web page 225. The display device 215 may be configured as any display device (e.g., presentation component 116 of FIG. 1) that is capable of presenting information to a user, such as a monitor, electronic display panel, touch-screen, liquid crystal display (LCD), plasma screen, one or more light-emitting diodes (LED), incandescent bulbs, a laser, an electroluminescent light source, a chemical light, a flexible light wire, and/or fluorescent light, or any other display type, or may comprise a reflective surface upon which the visual information is projected.

In one exemplary embodiment, the GUI workspace 205 rendered by the display device 215 is configured to surface the web page 225 that is associated with a search engine and/or content publisher. In embodiments, the web page 225 may reveal resultant content discovered by searching the Internet with a search term. The search term may be manually provided by a user at a query-entry area, or may be automatically generated by software. In addition, the search term may relate to a keyword that invokes surfacing ad impressions within the content regions 235. In other embodiments, the ad impressions rendered at the content regions 235 of the web page 225 may be selected by way of user-demographics of the end user navigating to the web page 225, content within the web page 225, a general context of the web page 225, a time of day, a day of the week, etc.

The server 250 and the computing device 220, shown in FIG. 2, may take the form of various types of computing devices, such as, for example, the computing device 100 described above with reference to FIG. 1. By way of example only and not limitation, the server 250 and/or the computing device 220 may be a personal computer, desktop computer, laptop computer, consumer electronic device, handheld device (e.g., personal digital assistant), various remote servers, processing equipment, and the like. It should be noted, however, that the invention is not limited to implementation on such computing devices but may be implemented on any of a variety of different types of computing devices within the scope of embodiments of the present invention.

Further, in one instance, the server 250 accommodates search engine software (not shown) designed for searching for information (e.g., user demographics) on the Internet and for gathering Internet search results in response to a user-submitted query. The Internet search may invoke the delivery engine 255 to select and surface ad impressions that satisfy the booked orders 280. In one embodiment, the search engine includes one or more web crawlers that mine available data (e.g., newsgroups, databases, or open directories) accessible via the Internet and build a table containing web addresses along with the subject matter of web pages identified as the search results that are relevant to search terms within the user-submitted query. The search engine may be accessed by Internet users through a web-browser application represented by the web page 225.

In another instance, the server 250 accommodates the delivery engine 255. Typically, the delivery engine 255 is configured to perform various tasks, including determining whether to accept a candidate order 270 from an advertiser 260, or content provider (e.g., utilizing the linear programs) and determining how to allocate impressions to the currently booked orders 280. In embodiments, the candidate orders 270 are associated with placement criteria or display specification 265 that indicates, among other things, a quantity of impressions of at least one advertisement to place, a time segment over which the quantity of impressions are anticipated to be placed, and at which content node the impressions are expected to be rendered. Although three different configurations of the placement criteria 265 have been described, it should be understood and appreciated by those of ordinary skill in the art that other types of suitable properties of an order may be specified in the placement criteria 265, and that embodiments of the present invention are not limited to those order attributes of the placement criteria 265 described herein. For instance, the placement criteria or display specification 265 may include, but is not limited to, one or more of the following properties: user-demographics, a time frame within a day to render the impressions, particular days(s) within the week to render the impressions, and websites that should be avoided when placing ads.

Processes conducted by the delivery engine 255 will be discussed with reference to one or more linear programs executed thereby. By way of background, and as discussed above, nodes in the content hierarchy can represent sets of leaf nodes. The linear program allocates orders to the leaf nodes, regardless of whether or not the order was placed at a leaf node or a non-leaf node. For example, an order for a certain number of impressions on a non-leaf “sports” node can be allocated to leaf nodes “sports\tennis,” “sports\football,” etc., assuming that tennis and football are the most specific descriptions of sports available in the topic graph hierarchy.

In general, the delivery engine 255 is responsible for selecting the booked orders 280 to satisfy. For instance, when an impression from a web page associated with a leaf node i is ready for receiving an impression, the delivery engine 255, in time segment t, can examine all matching order lines j whose impression goals xᵢⱼₜ have not been met. These order lines can be identified and sorted by priority. If there is a unique order line with a highest priority, the impression is delivered to that order line. Otherwise, the delivery engine 255 chooses uniformly at random between all highest-priority order lines.

As utilized herein, the phrase “leaf node” is not meant to be limiting, but may encompass any description of a web page. In one instance, the leaf node comprises a location within a topic graph that represents a specific description of the inventory that is permissible to allocate to satisfy the candidate order. A topic graph is shown at FIG. 3. In particular, FIG. 3 is an exemplary graphical depiction that illustrates a plurality of interconnected nodes located within a content graph 300, in accordance with an embodiment of the present invention. The topic graph 300 is composed of a plurality of nodes that are interconnected by way of a parent-child relationship, where each of the plurality of nodes represents a description of an article of the inventory (e.g., content region on a web page) being used to fulfill the booked orders. In another instance, the description of an article of inventory includes properties that expose a context of a web page.

The topic graph 300 may be arranged in any form or style known to one of ordinary skill in the art. In one instance, the topic graph 300 is a hierarchical organization of content within a web page. In another instance, a generalized hierarchy of the nodes may not fit within a standard tree-style pattern. For instance, a parent (e.g., root node C 315) may have a plurality of children (e.g., subnode C 330 and leaf node B 335), while a child (e.g., subnode C 330) may have a plurality of parents (e.g., root node B 310 and root node C 315). By way of example, the parent (e.g., root node C 315) may represent all web pages that include sports-related content, and have a plurality of children (e.g., subnode C 330 and leaf node B 335). The children, subnode C 330 and leaf node B 335, may be related to a narrower field of sports, such as football and baseball respectively.

Also, as discussed above, each child may have various parents. By way of example, the child (e.g., subnode C 330) may represent a characterization of football and may have parent topical descriptions of both sports (e.g., root node C 315) and outdoor activities (e.g., root node B 310). Accordingly, the higher up the node on the topic graph 300, the more general or topical the description of the web page. In contrast, the farther down the node on the topic graph 300, as illustrated, the more narrowed the characterization of the web page. The most focused descriptions of web pages are represented by the leaf nodes A 350, B 335, and C 345. These nodes do not have children and can be utilized to filter which impressions are associated with which orders.

Generally, the topic graph 300 describes, for any piece of inventory, the topical content by a path name. Advertisers can use the path name to target inventory that is relevant to their advertisements. Accordingly, the placement of the advertiser's ads within a content region is effective to generate revenue for the advertiser. As such, the advertiser may submit an order for a particular amount of advertisements to be placed, within a time frame, at impressions that are targeted by a path name.

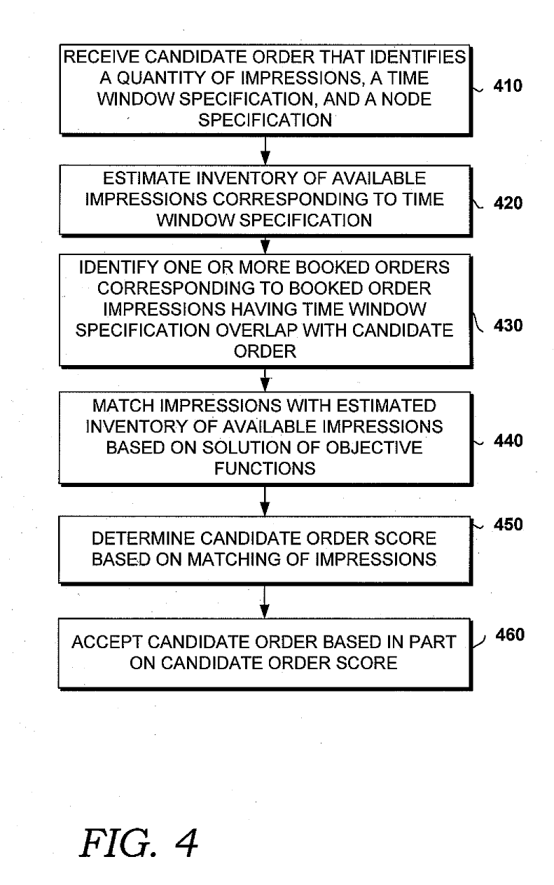

FIGS. 4-6 provide examples of additional embodiments according to the invention. In an embodiment shown in FIG. 4, a computer implemented method and/or one or more computer-storage media storing computer-useable instructions that, when executed by a computing device, perform a method for clustering messages are provided. The method includes receiving a candidate order 410 corresponding to a number of impressions and an associated display specification. The display specification can include a time window specification and a content node specification. An inventory of available impressions can be estimated 420 that correspond to the display specification for the candidate order. A plurality of booked orders having associated impressions can be identified 430. The booked orders can have time window specifications that overlap with the time window specification for the candidate order. The candidate order impressions and the booked order impressions can be matched 440 with the estimated inventory of available impressions. The matching can be based on solution of objective functions of a plurality of linear programs. A first objective function can comprise at least one slack variable related to an underdelivery of impressions. A second objective function can comprise at least one slack variable related to a deviation from smooth delivery of impressions over time. At least one of the first objective function and the second objective function can include a plurality of slack variables. For example, the first objective function can have a plurality of slack variables related to underdelivery of impressions. A candidate order score can be determined 450 based on the matching of the impressions. The candidate order can be accepted 460 based in part on the candidate order score.

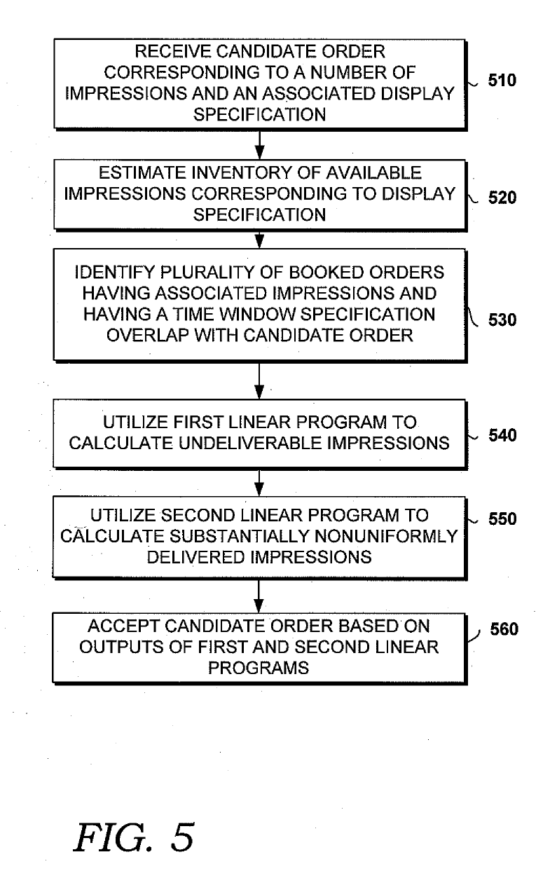

In another embodiment shown in FIG. 5, a computer implemented method and/or one or more computer-storage media storing computer-useable instructions that, when executed by a computing device, perform a method for clustering messages are provided. The method can include receiving a candidate order with associated placement criteria 510. The display specification can identify a quantity of impressions to place (such as advertising impressions), a time window specification over which the quantity of impressions are anticipated to be placed, and a node specification for nodes where the impressions are expected to be rendered. An inventory of impressions that are available for accommodating the quantity of impressions of the candidate order within the time window specification can be estimated 520. One or more booked orders can be identified 530, the booked orders having associated impressions that are scheduled to be placed within the time window specification. The impressions associated with the identified booked orders can compete to be placed at a node matching the node specification for the candidate order. A first linear program can be utilized 540 to calculate a number of impressions of the candidate order joined with impressions of the competing booked orders that are undeliverable by comparing the estimated inventory against the joined impressions, the undeliverable impressions being represented in the first linear program by a first plurality of slack variables. A second linear program can be utilized 550 to calculate a portion of the delivered impressions that are substantially nonuniformly delivered and a financial value of the estimated inventory allocated to the candidate order, the substantially nonuniformly delivered impressions being represented in the second linear program by a second plurality of slack variables. Preferably, the calculations utilizing the first linear program and the second linear program can be performed simultaneously. The candidate order can be accepted 560 based on an evaluation of outputs calculated by the first and second linear programs.

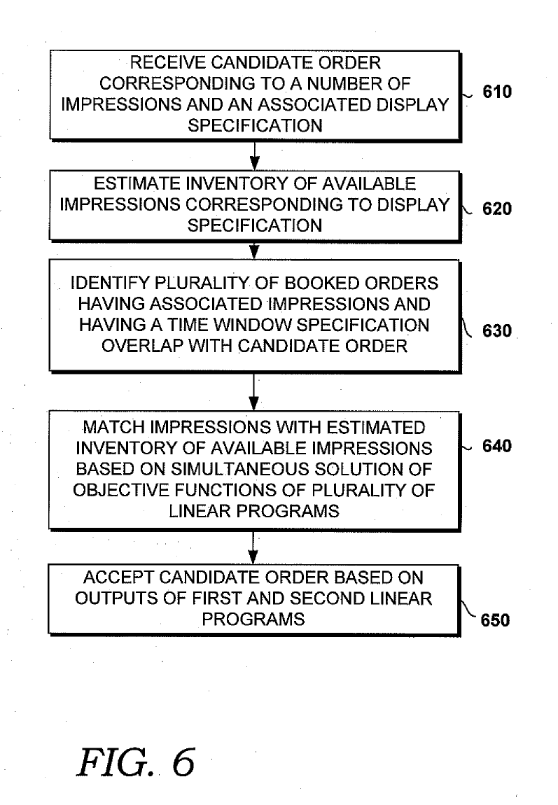

In still another embodiment shown in FIG. 6, a computer implemented method and/or one or more computer-storage media storing computer-useable instructions that, when executed by a computing device, perform a method for clustering messages are provided. The method includes receiving a candidate order 610 with associated placement criteria. The placement criteria can identify a quantity of impressions of at least one advertisement to place, a time window specification over which the quantity of impressions are anticipated to be placed, and a node specification for nodes where the impressions are expected to be rendered. An inventory of impressions that are available for accommodating the quantity of impressions of the candidate order within the time window specification can be estimated 620. One or more booked orders can be identified 630. The identified booked orders can have associated impressions that are scheduled to be placed within the time window specification. The impressions associated with the identified booked orders can compete to be placed at a node matching the node specification for the candidate order. The candidate order impressions and the booked order impressions can be matched 640 with the estimated inventory of available impressions. The matching can be based on simultaneous solution of object functions of a plurality of linear programs. The plurality of linear programs can include a first plurality of slack variables corresponding to undeliverable impressions and a second plurality of slack variables corresponding to substantially nonuniformly delivered impressions. The candidate order can be accepted 650 based on an evaluation of outputs calculated by the first and second linear programs.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for clustering messages, comprising:
receiving a candidate order corresponding to a number of impressions and an associated display specification, the display specification including a time window specification and a content node specification;
estimating an inventory of available impressions that correspond to the display specification for the candidate order;
identifying a plurality of booked orders having associated impressions, the booked orders having time window specifications that overlap with the time window specification for the candidate order;
matching the candidate order impressions and the booked order impressions with the estimated inventory of available impressions, the matching being based on solution of object functions of a plurality of linear programs, a first objective function comprising at least one slack variable related to an underdelivery of impressions, a second objective function comprising at least one slack variable related to a deviation from smooth delivery of impressions over time;
determining a candidate order score based on the matching of the impressions; and
accepting the candidate order based in part on the candidate order score,
wherein at least one of the first objective function and the second objective function includes a plurality of slack variables.

2. The computer-storage media of claim 1, wherein the plurality of slack variables further comprise a penalty weighting factor associated with at least one slack variable.

3. The computer-storage media of claim 1, wherein the candidate order is accepted based on the candidate order score being less than a predetermined value.

4. The computer-storage media of claim 1, wherein the matching is based on simultaneous solution of the objective functions of the plurality of linear programs.

5. The one or more computer-readable media of claim 1, wherein matching the advertising impressions of the candidate order and the booked advertising impressions with the estimated inventory of available impressions comprises solving the linear programs to minimize an underdelivery risk and minimize a deviation from smooth delivery, the solving of the linear programs being performed simultaneously.

6. The one or more computer-readable media of claim 5, wherein minimizing an underdelivery risk comprises minimizing a first objective function
$${\sum }_{j} A {V}_{j} ( {u}_{j 1} + ZP * {u}_{j 2} )$$
of a first linear program subject to at least one constraint, wherein uⱼ₁ and uⱼ₂ represent a number of the booked orders that will be potentially undelivered upon accepting the candidate order, ZP represents a penalty weighting, and AVⱼ represents a weighting assigned to at least one customer that submitted the booked orders.

7. The one or more computer-readable media of claim 6, wherein minimizing a first objective function of a first linear program subject to at least one constraint comprises minimizing the first object function subject to first constraints ∀ⱼuⱼ₂≧0 and ∀ⱼW_{c1}*Gⱼ≧uⱼ₁≧0 of the first linear program, wherein W_{c1}Gⱼ represents a percentage of the log of the booked orders scheduled to be placed at the leaf node within the time segment, and wherein the method further comprises ensuring that the delivery engine will not over-deliver the booked orders by solving the first object function in conjunction with the first constraint of the first linear program.

8. The one or more computer-readable media of claim 7, wherein minimizing a first objective function of a first linear program subject to at least one constraint comprises minimizing the first objective function subject to a second constraint
$${∀}_{j} {\sum }_{i ∈ {L}_{j} , t ∈ {T}_{j}} {x}_{ijt} = {G}_{j} - ( {u}_{j 1} + {u}_{j 2} )$$
of the first linear program, wherein Gⱼ represents the log of the booked orders scheduled to be placed at the leaf node within the time segment, wherein solving the first object function in conjunction with the second constraint of the first linear program provides equivalence between the potential undelivered booked orders and the scheduled booked orders with consideration of periods of time Tⱼ within the time segment that the candidate order is active.

9. The one or more computer-readable media of claim 8, wherein minimizing a first objective function of a first linear program subject to at least one constraint comprises minimizing the first object function subject to a third constraint
$${∀}_{i , j , t} {x}_{ijt} \leq {C}_{it} {S}_{it} ( j ) p ( {U}_{j} ) - {\sum }_{k \neq js \cdot t \cdot {R}_{k} \geq {R}_{j}} {x}_{ikt} \frac{{S}_{it} ( j , k )}{{S}_{it} ( k )} p 〈 {U}_{j} \vert {U}_{k} 〉$$
of the first linear program, wherein a first term CᵢₜSᵢₜ(j)p(Uⱼ) represents the estimated inventory of impressions available that meet the placement criteria and a second term
$${\sum }_{k \neq js \cdot t \cdot {R}_{k} \geq {R}_{j}} {x}_{ikt} \frac{{S}_{it} ( j , k )}{{S}_{it} ( k )} p 〈 {U}_{j} \vert {U}_{k} 〉$$
represents a portion of the estimated inventory of impressions that is ostensibly allocated to the booked orders submitted by customers that have a priority level which ranks higher or equal to a priority level assigned to an advertiser submitting the candidate order.

10. The one or more computer-readable media of claim 9, wherein minimizing the first objective function subject to a third constraint of the first linear program comprises ascertaining a number of impressions, which satisfy the placement criteria, within the estimated inventory that are available upon removing those impressions allocated to the high-priority-level customers while taking into account the active time periods and user-demographics designated by the booked orders, wherein the placement criteria specify the active time periods and the user-demographics associated with placing the candidate order.

11. The one or more computer-readable media of claim 5, wherein minimizing a deviation from smooth delivery comprises minimizing a second objective function
$$( \sum A {V}_{j} ( {δ}_{jt 1} + ZQ {δ}_{jt 2} ) ) + Γ ( {\sum }_{ijt} {X}_{ijt} {R}_{i} )$$
of a second linear program subject to at least one constraint, wherein a first term (ΣAVⱼ(δⱼₜ₁+ZQδⱼ₂ₜ)) represents a uniformity at which the impressions are delivered throughout the time segment, and a second term
$$Γ ( {\sum }_{ijt} {X}_{ijt} {R}_{i} )$$
represents a value of the impressions that are allocated to the booked orders.

12. The one or more computer-readable media of claim 11, wherein minimizing a second objective function of a second linear program subject to at least one constraint comprises minimizing the second objective function subject to first constraints ∀ⱼδⱼ₂ₜ≧0 and ∀ⱼW_{c2}*DFⱼₜ≧δⱼ₁ₜ≧0 of the second linear program, wherein W_{c2}Gⱼ represents a percentage of the log of the booked orders scheduled to be placed at the leaf node within the time segment.

13. The one or more computer-readable media of claim 12, wherein minimizing a second objective function of a second linear program subject to at least one constraint comprises minimizing the second objective function subject to a second constraint
$${∀}_{j} {\sum }_{i ∈ {L}_{j} , t ∈ {T}_{j}} {x}_{ijt} = {G}_{j} - ( {u}_{j 1} + {u}_{j 2} )$$
of the second linear program, wherein Gⱼ represents the log of the booked orders scheduled to be placed at the leaf node within the time segment.

14. The one or more computer-readable media of claim 13, wherein minimizing a second objective function of a second linear program subject to at least one constraint comprises minimizing the second objective function subject to a third constraint
$${∀}_{i , j , t} {x}_{ijt} \leq {C}_{it} {S}_{it} ( j ) p ( {U}_{j} ) - {\sum }_{k \neq js \cdot t \cdot {R}_{k} \geq {R}_{j}} {x}_{ikt} \frac{{S}_{it} ( j , k )}{{S}_{it} ( k )} p 〈 {U}_{j} \vert {U}_{k} 〉$$
of the second linear program, wherein a first term CᵢₜSᵢₜ(j)p(Uⱼ) represents the estimated inventory of impressions available that meet the placement criteria and a second term
$${\sum }_{k \neq js \cdot t \cdot {R}_{k} \geq {R}_{j}} {x}_{ikt} \frac{{S}_{it} ( j , k )}{{S}_{it} ( k )} p 〈 {U}_{j} \vert {U}_{k} 〉$$
represents a portion of the estimated inventory of impressions that is ostensibly allocated to the booked orders submitted by customers that have a priority level which ranks higher or equal to a priority level assigned to an advertiser submitting the candidate order.

15. The one or more computer-readable media of claim 14, wherein minimizing a second objective function of a second linear program subject to at least one constraint comprises minimizing the second objective function subject to a fourth constraint
$${∀}_{j , t} [ {\sum }_{i ∈ {L}_{j}} {x}_{ijt} - {F}_{jt} {G}_{j} ] \leq D {F}_{jt} {G}_{j} + ( {δ}_{j 1 t} + {δ}_{j 2 t} )$$
of the second linear program, wherein a first term
$${∀}_{j , t} [ {\sum }_{i ∈ {L}_{j}} {x}_{ijt} - {F}_{jt} {G}_{j} ]$$
represents an accumulated difference between a uniform distribution and a scheduled allocation of the impressions over the time segment, DFⱼₜGⱼ represents a variation-tolerance threshold, and δⱼ₁ₜ+δⱼ₂ₜ represents a distance of deviation from a prescribed range of uniformity.

16. A computer implemented method for determining whether to accept a candidate order taking into account booked orders competing for inventory, the method comprising:
receiving a candidate order with associated placement criteria that identifies a quantity of impressions of at least one advertisement to place, a time window specification over which the quantity of impressions are anticipated to be placed, and a node specification for nodes where the impressions are expected to be rendered;
estimating an inventory of impressions that are available for accommodating the quantity of impressions of the candidate order within the time window specification;
identifying one or more booked orders having associated impressions that are scheduled to be placed within the time window specification, wherein impressions associated with the identified booked orders compete to be placed at a node matching the node specification for the candidate order;
utilizing a first linear program to calculate a number of impressions of the candidate order joined with impressions of the competing booked orders that are undeliverable by comparing the estimated inventory against the joined impressions, the undeliverable impressions being represented in the first linear program by a first plurality of slack variables;
utilizing a second linear program to calculate a portion of the delivered impressions that are substantially nonuniformly delivered and a financial value of the estimated inventory allocated to the candidate order, the substantially nonuniformly delivered impressions being represented in the second linear program by a second plurality of slack variables; and
accepting the candidate order based on an evaluation of outputs calculated by the first and second linear programs
wherein the calculations utilizing the first linear program and the second linear program are performed simultaneously.

17. The method of claim 16, wherein the first plurality of slack variables and the second plurality of slack variables have associated importance weightings, the importance weightings for the first plurality of slack variables being different from the importance weightings for the second plurality of slack variables.

18. The method of claim 16, wherein a penalty weighting is associated with at least one slack variable of the first plurality of slack variables.

19. The method of claim 16, wherein a penalty weighting is associated with at least one slack variable of the second plurality of slack variables.

20. A computer implemented method for determining whether to accept a candidate order taking into account booked orders competing for inventory, the method comprising:
receiving a candidate order with associated placement criteria that identifies a quantity of impressions of at least one advertisement to place, a time window specification over which the quantity of impressions are anticipated to be placed, and a node specification for nodes where the impressions are expected to be rendered;
estimating an inventory of impressions that are available for accommodating the quantity of impressions of the candidate order within the time window specification;
identifying one or more booked orders having associated impressions that are scheduled to be placed within the time window specification, wherein impressions associated with the identified booked orders compete to be placed at a node matching the node specification for the candidate order;
matching the candidate order impressions and the booked order impressions with the estimated inventory of available impressions, the matching being based on simultaneous solution of objective functions of a plurality of linear programs, the plurality of linear programs including a first plurality of slack variables corresponding to undeliverable impressions and a second plurality of slack variables corresponding to substantially nonuniformly delivered impressions; and
accepting the candidate order based on an evaluation of outputs calculated by the first and second linear programs.
